(19) United States
(12) Patent Application Publication
(10) Pub. No.: US 2025/0142641 A1
(43) Pub. Date: May 1, 2025

(54) METHOD FOR SIDELINK COMMUNICATION AND COMMUNICATIONS DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN); Boyuan ZHANG, Dongguan (CN)

(21) Appl. No.: 19/005,480

(22) Filed: Dec. 30, 2024

Related U.S. Application Data
(63) Continuation of application No. PCT/CN2022/123251, filed on Sep. 30, 2022.

(51) Int. Cl. H04W 74/08; H04W 28/02; H04W 92/18

(52) U.S. Cl. CPC H04W 74/0875; H04W 28/0268; H04W 92/18

(57) ABSTRACT

A method for sidelink communication and a communications device are provided. The method for sidelink communication includes: determining, by a first device, a first CAPC value for sidelink communication, where the first CAPC value is associated with a PQI. The communications device includes a memory and a processor, where the memory is configured to store a program, and the processor is configured to invoke the program in the memory and run the computer program, to cause the method for sidelink communication to be implemented.

### CROSS-REFERENCE TO RELATED APPLICATIONS

This application is a continuation of International Application No. PCT/CN2022/123251, filed on Sep. 30, 2022, the disclosure of which is hereby incorporated by reference in its entirety.

### TECHNICAL FIELD

This application relates to the field of communications technologies, and more specifically, to a method for sidelink communication and a communications device.

### BACKGROUND

In a Uu interface communications system based on a grant-free spectrum, a channel access priority class (CAPC) is determined based on a configuration of a network device. Specifically, the network device may determine a CAPC value by referring to a 5G quality of service identifier (5QI) value. In a sidelink communications system based on a grant-free spectrum, there is no proper technical solution to determine a CAPC value.

### SUMMARY

This application provides a method for sidelink communication and a communications device. The following describes the aspects related to this application.

According to a first aspect, a method for sidelink communication is provided, including: determining, by a first device, a first CAPC value for sidelink communication, where the first CAPC value is associated with a PC5 quality of service index (PQI).

According to a second aspect, a communications device is provided, including: a determining unit, configured to determine a first CAPC value for sidelink communication, where the first CAPC value is associated with a PQI.

According to a third aspect, a communications device is provided, including a processor and a memory. The memory is configured to store one or more computer programs, and the processor is configured to invoke the computer program in the memory to cause the communications device to execute some or all of the steps of the method according to the first aspect.

According to a fourth aspect, an embodiment of this application provides a communications system, and the system includes the communications device described above. In another possible design, the system may further include another device that interacts with the communications device in the solutions provided in embodiments of this application.

According to a fifth aspect, an embodiment of this application provides a computer-readable storage medium. The computer-readable storage medium stores a computer program, and the computer program causes a terminal to execute some or all of the steps of the methods according to the foregoing aspects.

According to a sixth aspect, an embodiment of this application provides a computer program product. The computer program product includes a non-transitory computer-readable storage medium that stores a computer program, and the computer program is operable to cause a terminal to execute some or all of the steps of the methods according to the foregoing aspects. In some implementations, the computer program product may be a software installation package.

According to a seventh aspect, an embodiment of this application provides a chip. The chip includes a memory and a processor, and the processor may invoke and run a computer program in the memory, to implement some or all of the steps of the methods according to the foregoing aspects.

### BRIEF DESCRIPTION OF DRAWINGS

FIG. 1 is a schematic diagram of a wireless communications system to which embodiments of this application are applied.

FIG. 2 is an example diagram of an application scenario of sidelink communication in a first mode.

FIG. 3 is an example diagram of an application scenario of sidelink communication in a second mode.

FIG. 4 is a schematic flowchart of a method for sidelink communication according to an embodiment of this application.

FIG. 5 is a schematic flowchart of another method for sidelink communication according to an embodiment of this application.

FIG. 6 is a schematic flowchart of another method for sidelink communication according to an embodiment of this application.

FIG. 7 is a schematic structural diagram of a communications device according to an embodiment of this application.

FIG. 8 is a schematic structural diagram of an apparatus for communication according to an embodiment of this application.

### DESCRIPTION OF EMBODIMENTS

The technical solutions in this application are described below with reference to the accompanying drawings. For ease of understanding, the following first describes terms and communication processes involved in this application with reference to FIG. 1 to FIG. 3.

### Communications System

FIG. 1 is an example diagram of a wireless communications system 100 to which embodiments of this application are applicable. The wireless communications system 100 may include one or more communications devices. For example, the one or more communications devices may include a network device 110 and terminals 121 to 129. The network device 110 may provide communication coverage for a specific geographic area, and may communicate with a terminal within the coverage area.

In some implementations, terminal devices may communicate with each other through a sidelink (SL). Sidelink communication may also be referred to as proximity service (ProSe) communication, unilateral communication, side link communication, device-to-device (D2D) communication, direct link communication, or the like. A vehicle to everything (V2X) system may also be implemented in a manner of direct communication between terminals (that is, sidelink communication).

In some implementations, sidelink data may be transmitted between terminal devices through a sidelink. The sidelink data may include data and/or control signalling. In some implementations, the sidelink data may be, for example, a physical sidelink control channel (PSCCH), a physical sidelink shared channel (PSSCH), a PSCCH demodulation reference signal (DMRS), a PSSCH DMRS, a PSFCH, or a sidelink synchronization signal block (S-SSB). The S-SSB includes a sidelink primary synchronization signal (S-PSS), a sidelink secondary synchronization signal (S-SSS), and a physical sidelink broadcast channel (PSBCH).

Different from a conventional cellular system in which communication data is received or transmitted by using a network device, a manner of direct communication between terminal devices is used in a sidelink communications system (for example, a vehicle to everything system). Therefore, sidelink communication has higher spectral efficiency and a lower transmission latency.

With reference to FIG. 1, the following describes several common sidelink communication scenarios. Sidelink communication may be classified into three scenarios depending on whether terminals on a sidelink are located in coverage of the network device. In a scenario 1, the terminals perform sidelink communication within the coverage of the network device. In a scenario 2, some of the terminals perform sidelink communication within the coverage of the network device. In a scenario 3, the terminals perform sidelink communication outside the coverage of the network device.

As shown in FIG. 1, in the scenario 1, terminals 121 and 122 may communicate with each other through a sidelink, and the terminals 121 and 122 are both within the coverage of the network device 110. In other words, the terminals 121 and 122 are both within coverage of a same network device 110. In this scenario, the network device 110 may transmit configuration signalling to the terminals 121 and 122, and accordingly, the terminals 121 and 122 communicate with each other through the sidelink based on the configuration signalling.

As shown in FIG. 1, in the scenario 2, terminals 123 and 124 may communicate with each other through a sidelink, the terminal 123 is within the coverage of the network device 110, and the terminal 124 is outside the coverage of the network device 110. In this scenario, the terminal 123 receives configuration information from the network device 110, and performs communication through the sidelink based on a configuration of configuration signalling. However, since the terminal 124 is outside the coverage of the network device 110, the terminal 124 cannot receive the configuration information from the network device 110. In this case, the terminal 124 may obtain a configuration of sidelink communication based on pre-configured configuration information and/or configuration information transmitted by the terminal 123 within the coverage, so that the terminal 124 communicates with the terminal 123 through the sidelink based on the obtained configuration.

In some cases, the terminal 123 may transmit the configuration information to the terminal 124 through a sidelink broadcast channel (PSBCH), to configure the terminal 124 to perform communication through the sidelink.

As shown in FIG. 1, in the scenario 3, terminals 125 to 129 are all outside the coverage of the network device 110 and cannot communicate with the network device 110. In this case, all the terminals may perform sidelink communication based on pre-configuration information.

In some cases, the terminals 127 to 129 outside the coverage of the network device may form a communication cluster, and the terminals 127 to 129 in the communication cluster may communicate with each other. In addition, the terminal 127 in the communication cluster may serve as a central control node, which is also referred to as a cluster header (CH). Correspondingly, the other terminals in the communication cluster may be referred to as “cluster members”.

The terminal 127, as the CH, may have one or more of the following functions: being responsible for establishment of the communication cluster; joining and leaving of the cluster members; resource coordination, allocation of sidelink transmission resources for the cluster members, and receiving of sidelink feedback information from the cluster members; resource coordination with another communication cluster; or the like.

It should be noted that FIG. 1 exemplarily shows one network device and a plurality of terminal devices. In at least one embodiment, the wireless communications system 100 may include a plurality of network devices, and another quantity of terminal devices may be included in coverage of each network device. This is not limited in embodiments of this application.

In at least one embodiment, the wireless communications system 100 may further include another network entity such as a network controller or a mobility management entity. This is not limited in embodiments of this application.

It should be understood that the technical solutions of embodiments of this application may be applied to various communications systems, such as a 5th generation (5G) system or new radio (NR), a long term evolution (LTE) system, an LTE frequency division duplex (FDD) system, and LTE time division duplex (TDD). The technical solutions provided in this application may be further applied to a future communications system, such as a 6th generation mobile communications system or a satellite communications system.

The terminal in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal device, a wireless communications device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city a wireless terminal in smart home, or the like. In at least one embodiment, the terminal device may function as a base station. For example, the terminal device may function as a scheduling entity that provides sidelink data between terminal devices in V2X, D2D, or the like. For example, a cellular phone and a vehicle communicate with each other by using sidelink data. A cellular phone and a smart household device communicate with each other, without relaying a communication signal by using a base station.

The network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in the following, or replace with the following names, for example: a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, V2X, and machine-to-machine (M2M) communication, a network side device in a 6G network, a device that functions as a base station in a future communications system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to function as a mobile base station, and one or more cells may move based on a location of the mobile base station. In other examples, a helicopter or an unmanned aerial vehicle may be configured to function as a device that communicates with another base station.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may also be implemented by software functions running on hardware, or by virtualization functions instantiated on a platform (for example, a cloud platform).

### Mode of Sidelink Communication

Two modes (or referred to as transmission modes) of sidelink communication are defined in some standards or protocols (for example, 3rd generation partnership project (3GPP)): a first mode (mode-1) and a second mode (mode-2).

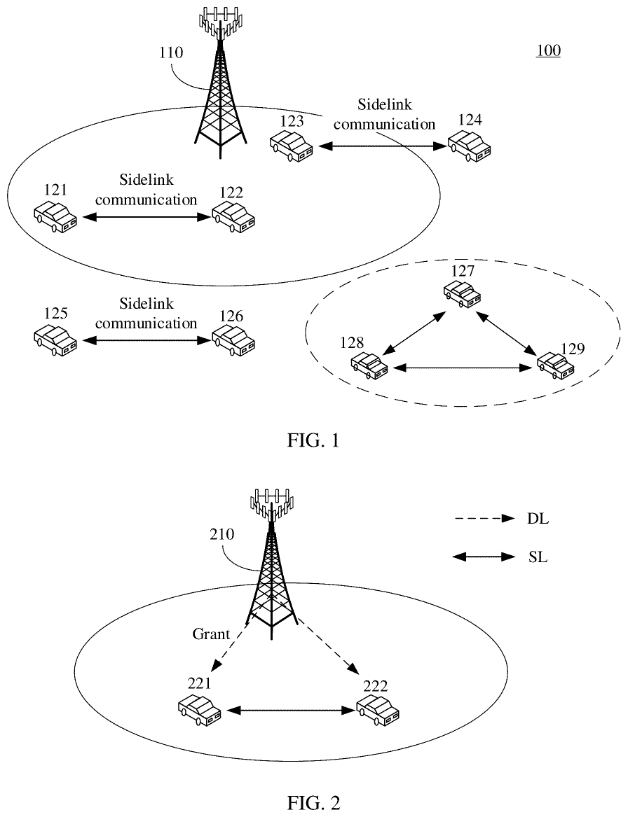

In the first mode, a resource (the resource mentioned in this application may also be referred to as a transmission resource such as a time frequency resource) of a terminal device is allocated by a network device. The terminal device may transmit data on a sidelink based on the resource allocated by the network device. The network device may allocate a resource for a single time of transmission to the terminal device, or may allocate a resource for semi-static transmission to the terminal device. The first mode may be applied to a scenario in which there is coverage of the network device, for example, a scenario shown in FIG. 2. In the scenario shown in FIG. 2, a terminal device 221 and a terminal device 222 are located within network coverage of a network device 210. The network device 210 may allocate a resource used in a sidelink transmission process to the terminal device 221 and the terminal device 222. As shown in FIG. 2, the network device may perform granting through a downlink (DL), to allocate the resource used in the sidelink transmission process to the terminal device 221 and the terminal device 222, so that the terminal device 221 and the terminal device 222 may communicate with each other on a sidelink (SL). In some embodiments, the first mode may also be referred to as a mode A.

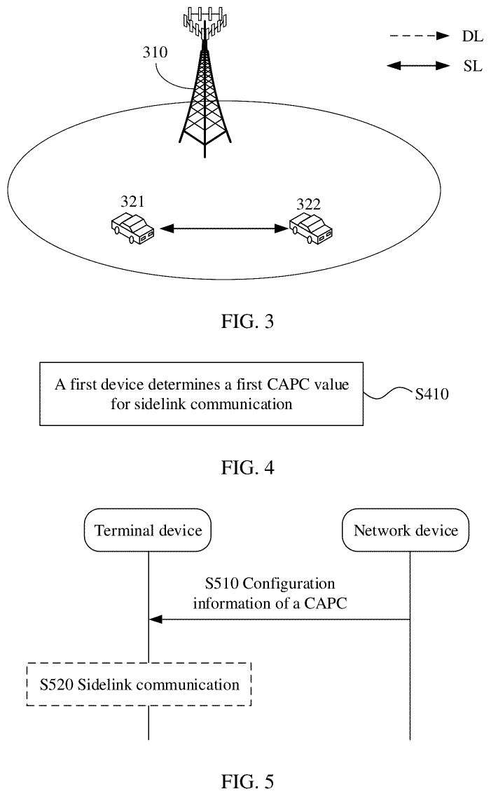

In the second mode, the terminal device may independently select one or more resources from a resource pool (RP). Then, the terminal device may perform sidelink transmission based on the selected resource. For example, in a scenario shown in FIG. 3, a terminal device 321 is located in network coverage. The terminal device 321 may independently select a resource from a pre-configured resource pool to perform sidelink transmission. Alternatively, the terminal device 321 may independently select one or more resources from a resource pool configured by a network device 310, to perform sidelink transmission. It should be noted that if the terminal device 321 is located outside the network coverage, the terminal device 321 may also perform resource selection by using the second mode. In some embodiments, the second mode may also be referred to as a mode B.

### Research Progress of Sidelink Communication in 3GPP

In 3GPP, sidelink communication is studied at different stages.

In the 3GPP release (Rel) 12 or 13, device-to-device communication is for a proximity-based service (ProSe) scenario, and is mainly for a public security service. In ProSe, a location of a resource pool in time domain may be configured. For example, the resource pool is discontinuous in time domain. Based on the foregoing manner, a terminal device may discontinuously transmit/receive data on a sidelink, thereby achieving a power saving effect.

In the Rel-14 or a Rel-15, a scenario of communication between vehicles is studied in a V2X system. V2X is mainly for services of communication between vehicles or between a vehicle and a person that move at a relatively high speed. In V2X, because a vehicle-mounted system has continuous power supply, power efficiency is not a major problem, but a latency of data transmission is a major problem. Therefore, a terminal device is required to perform continuous transmission and reception in a system design.

In the Rel-14, a further enhancement to LTE DTD (FeD2D) technology studies a scenario in which a wearable device accesses a network by using a terminal device, and is mainly for a scenario of a low moving speed and low power access. In FeD2D, in a pre-research stage, 3GPP concluded that a network device may configure a discontinuous reception (DRX) parameter of a remote terminal by using a relay terminal. However, this topic is not further standardized. Therefore, the details of how to configure DRX are not conclusive.

In the NR V2X-related research, based on a broadcast scenario of LTE V2X, NR V2X is further extended to a unicast scenario and a multicast scenario. Similar to LTE V2X, NR V2X also defines the foregoing two resource authorization modes: the first mode and the second mode. In addition, in NR V2X, a terminal device may be in a mixed mode. In the mixed mode, the terminal device may obtain a resource by using the first mode, and may also obtain a resource by using the second mode. The foregoing resource obtaining may be indicated in a sidelink grant manner. That is, a sidelink grant may indicate time-frequency locations of corresponding PSCCH and PSSCH resources.

In LTE V2X, hybrid automatic repeat request (HARQ) retransmission may be initiated by the terminal device, and the HARQ is based on no feedback. Unlike LTE V2X, feedback-based HARQ retransmission is introduced into NR V2X. The feedback-based HARQ retransmission may be applied to unicast communication, and may also be applied to multicast communication.

Similar to LTE V2X, in NR V2X, because a vehicle-mounted system has continuous power supply, power efficiency is not a major problem, but a latency of data transmission is a major problem. Therefore, a terminal device is required to perform continuous transmission and reception in a system design.

### Indication of Quality of Service (QOS) in Sidelink Communication

In sidelink communication, a PC5 interface QoS index (PQI) may be used to index QoS characteristics. In some sidelink communications systems, QoS/PQIs may be shown in Table 1.

TABLE 1

| | | | | | | Default | | |
|---|---|---|---|---|---|---|---|---|
| | | Default | Packet | | Packet | maximum | Default | |
| PQI | Resource | priority | delay | | error | data burst | averaging | Example |
| value | type | level | budget | | rate | volume | window | services |
| 24 | Guaranteed | 1 | 150 | ms | 10⁻² | N/A | 2000 ms | Mission critical |
| | bit rate | | | | | | | user plane push |
| | (GBR) | | | | | | | to talk voice |
| | (Note 1) | | | | | | | (e.g. MCPTT) |
| 25 | | 2 | 200 | ms | 10⁻² | N/A | 2000 ms | Non-mission- |
| | | | | | | | | critical user |
| | | | | | | | | plane push to |
| | | | | | | | | talk voice |
| 26 | | 2 | 200 | ms | 10⁻³ | N/A | 2000 ms | Mission critical |
| | | | | | | | | video user plane |
| 60 | Non- | 1 | 120 | ms | 10⁻⁶ | N/A | N/A | Mission critical |
| | guaranteed | | | | | | | delay sensitive |
| | bit rate | | | | | | | signalling (e.g. |
| | (non-GBR) | | | | | | | MC-PTT signalling) |
| 61 | | 6 | 400 | ms | 10⁻⁶ | N/A | N/A | Mission critical |
| | | | | | | | | data (e.g. example |
| | | | | | | | | services are the |
| | | | | | | | | same as 5QI 6/8/9 |
| | | | | | | | | as specified in |
| | | | | | | | | TS 23.501 [4]) |
| 92 | Delay critical | 5 | 5 | ms | 10⁻⁴ | 20000 | 2000 ms | Interactive |
| | guaranteed | | | | | bytes | | service - consume |
| | bit rate | | | | | | | VR content with |
| | (delay critical | | | | | | | high compression |
| | GBR) | | | | | | | rate via tethered |
| | | | | | | | | VR headset (see |
| | | | | | | | | TS 22.261 [6]) |
| 93 | (Note 1) | 6 | 10 | ms | 10⁻⁴ | 20000 | 2000 ms | Interactive |
| | | | | | | bytes | | service - consume |
| | | | | | | | | VR content with |
| | | | | | | | | low compression |
| | | | | | | | | rate via tethered |
| | | | | | | | | VR headset; |
| | | | | | | | | Gaming or |
| | | | | | | | | Interactive Data |
| | | | | | | | | Exchanging (See |
| | | | | | | | | TS 22.261 [6]) |

(Note 1):
GBR and delay critical GBR PQIs can only be used for unicast PC5 communications.

### Unlicensed Spectrum Communication

An unlicensed spectrum is a spectrum that is classified by a country and a region and that can be used for communication of a radio device. The spectrum is generally considered as a shared spectrum. That is, a communications device can use the spectrum provided that a regulatory requirement set for the spectrum by a country or a region is met, without applying for a dedicated spectrum grant from a dedicated spectrum management authority of the country or the region. The unlicensed spectrum may also be referred to as a shared spectrum, a grant-free spectrum, an unlicensed band, a grant-free band, or the like.

For a Uu interface-based communication process, a network device (for example, a gNB) may operate in a dynamic or semi-static channel access mode. In the foregoing two channel access modes, the network device and the terminal device may apply listen before talk (LBT) before performing transmission on a cell configured with unlicensed spectrum channel access. When LBT is applied, a data transmit end (transmitter) monitors or senses a channel to determine whether the channel is idle or busy. When it is sensed that the channel is idle, the data transmit end may perform data transmission.

After LBT on a channel of an unlicensed spectrum succeeds, a time length in which the communications device performs signal transmission by using the channel of the unlicensed spectrum may be represented by a channel occupation time (COT). To ensure fairness, in one time of transmission, duration in which the communications device performs signal transmission by using the channel of the unlicensed spectrum cannot exceed a maximum channel occupancy time (MCOT).

A type of a channel access process may include a channel access process type 1 and a channel access process type 2. The channel access process type 1 is random backoff multi-slot channel detection based on contention window size adjustment, and a corresponding CAPC may be selected based on a priority of a to-be-transmitted service. The channel access process type 2 is a channel access manner based on a listening slot of a fixed length. In embodiments of this application, a channel access manner is also referred to as an LBT manner, and a channel access process is also referred to as an LBT process.

The channel access process type 1 is mainly used by a communications device to initiate channel occupation. The channel access process type 2 is mainly used by a communications device to share channel occupation.

The channel access process type 2 includes a channel access process type 2A, a channel access process type 2B, and a channel access process type 2C. The following describes the type 2A, the type 2B, and the type 2C.

In a case that the communications device performs channel access by using the type 2A, a channel detection manner of the communications device is channel detection of 25 μs. Specifically, in a case that channel access of the channel access process type 2A is performed, the communications device may perform channel monitoring of 25 us before transmission starts, and perform transmission after the channel monitoring succeeds (that is, a channel is idle).

In a case that the communications device performs channel access by using the type 2B, a channel detection manner of the communications device is channel detection of 16 μs. Specifically, in a case that channel access of the channel access process type 2B is performed, the communications device may perform channel monitoring of 16 us before transmission starts, and perform transmission after the channel monitoring succeeds (that is, a channel is idle). A size of a gap between a start location of the transmission and an end location of previous transmission is 16 μs, or a size of a gap between a start location of the transmission and an end location of previous transmission is greater than or equal to 16 us and is less than 25 μs.

In a case that the communications device performs channel access by using the type 2C, the communications device may perform transmission without performing channel detection after the gap ends. Specifically, in a case that channel access of the channel access process type 2C is performed, the communications device may directly perform transmission, where a size of a gap between a start location of the transmission and an end location of previous transmission is less than or equal to 16 μs. A length of the transmission does not exceed 584 μs.

When the terminal device detects a consistent uplink LBT fault, the terminal device may perform processing by using measures specified in the standard TS 38.321 [6]. The detection is based on each bandwidth part (BWP) and is based on all uplink transmission within the BWP. When a consistent uplink LBT fault is detected in a secondary cell (SCell), the terminal device may report the fault to a corresponding network device (for example, a gNB) by using a medium access control control element (MAC-CE) in a serving cell that is different from the SCell in which the fault is detected (a master node (MN) is used for a master cell group (MCG) and a secondary node (SN) is used for a secondary cell group (SCG)). If no resource is available for transmitting a MAC-CE, the terminal device may transmit a scheduling request (SR). When a consistent uplink LBT fault is detected in a special cell (SpCell), the terminal device may switch to another uplink (UL) BWP on which a random access channel (RACH) resource is configured in the cell, initiate a RACH, and report the fault by using a MAC-CE. When a plurality of UL BWPs may be used for switching, the terminal device may select one of the UL BWPs. For a primary secondary cell (PSCell), if a consistent uplink LBT fault is detected on all UL BWPs configured with RACH resources, the terminal device may declare an SCG radio link failure (RLF) and report the fault to a mobile network (MN) by using SCGFailureInformation. For a primary cell (PCell), if an uplink LBT fault is detected on all UL BWPs configured with RACH resources, the terminal device may declare an RLF.

### COT Sharing Mechanism

After a communications device initiates a COT, in addition to using a resource within the COT for transmission, the communications device may share the resource within the COT with another communications device for transmission. For example, a first communications device may initiate sharing of a COT, and share the obtained COT with a second communications device. The second communications device may inherit the COT and use the COT to perform data transmission. The second communications device may be referred to as a shared COT communications device (for example, may include a shared COT terminal device).

A principle of the COT sharing may include: a CAPC level corresponding to a service transmitted by the second communications device should not be lower than a CAPC level used when the first communications device obtains the COT.

In a case that the first communications device shares a resource within the COT with the second communications device, the second communications device may perform channel access by using the channel access process type 2.

Some communications systems (for example, a sidelink over unlicensed spectrum (SL-U) system) support a direct COT sharing mechanism of a terminal device. That is, when a terminal device successfully performs channel access by using the type 1 and performs sidelink transmission by using a channel, the terminal device may share the channel with another terminal device for sidelink transmission. In other words, COT sharing may be supported between terminal devices that establish a PC5 radio resource control (RRC) connection. For example, a terminal device 1 successfully performs channel access by using the type 1, and transmits a PSCCH/PSSCH to a terminal device 2. The terminal device 1 may share a COT with the terminal device 2, so that the terminal device 2 transmits a PSFCH to the terminal device 1. In this case, the terminal device 2 only needs to perform a channel access process of the type 2 within the shared COT.

The following uses the SL-U system as an example to describe the COT sharing mechanism. It may be understood that the COT sharing mechanism described below may also be applicable to another communications system.

To ensure that a communications device in the SL-U system can continuously use a channel within an obtained COT, a guard period (GP) symbol of 16 us may be supported in an SL-U frame structure. In some implementations, a GP length may be reduced by means of cyclic prefix extension (CP extension).

The terminal device may complete COT sharing by indicating COT sharing information. A shared COT terminal device may implement COT sharing by inheriting or forwarding the COT sharing information. The COT information may be carried in sidelink control information (SCI) of physical layer control signalling. If the COT sharing information is carried in the SCI, a processing time may be considered for implementation of COT sharing. The processing time may be a time for which the terminal device receives and decodes the COT sharing information carried in the SCI. Further, a relationship between the processing time and a minimum monitoring time specified in the regulations may be considered.

The COT sharing information indicated by the terminal device that initiates the COT may include one or more of the following information: remaining COT duration information, available sub-band information (the information may be obtained by using resource indication information carried in the SCI), CAPC information, COT sharing identity (ID) information, or the like.

The COT sharing information inherited by the shared COT terminal device may include: remaining COT duration information, available sub-band information (the information may be obtained by using resource indication information carried in the SCI), CAPC information, COT sharing ID information, and the like.

The COT sharing ID information may include at least one or more of the following: a target terminal ID, a terminal group ID, service identity information, or a sidelink zone ID (SL zone ID).

Inheritance and forwarding of the COT sharing information may meet the following condition of the processing time: a time length between an end location of a symbol for receiving the SCI and a start location of a symbol for transmitting the SCI is greater than or equal to a first time length (for example, may be denoted by T_{proc,SI-U}), where T_{proc,S-U} may be the processing time that needs to be considered for inheritance and forwarding of the COT sharing information.

When a plurality of pieces of COT sharing information that meets the condition of the processing time is received by the terminal device, proper COT sharing information may be selected for inheritance and forwarding by using a solution 1 and/or a solution 2.

Solution 1: The terminal device may select, based on remaining COT lengths of the plurality of pieces of COT sharing information, COT sharing information with the longest remaining COT length for inheritance and forwarding. The COT sharing information with the longest remaining COT length forwarded by the terminal device may be determined relative to a transmission instant of the terminal device.

Solution 2: When remaining COT lengths determined based on the plurality of pieces of COT sharing information are the same, the terminal device may select, based on CAPC values of the plurality of pieces of COT sharing information, COT sharing information with a maximum CAPC value for inheritance and forwarding.

It should be noted that the plurality of pieces of COT sharing information may be a plurality of pieces of COT sharing information that can be used by the terminal device. In addition to the foregoing solutions, COT information may be inherited and forwarded based on other information. For example, COT information may be inherited and forwarded based on resource block set (RB set) information in the COT sharing information.

The terminal device may be allowed to perform COT sharing in a case that a COT sharing condition is met.

In an implementation, the COT sharing condition may be determined based on the COT sharing ID information. For example, a terminal group may be determined based on the COT sharing ID information, and a COT may be shared between terminal devices in the terminal group.

In an implementation, the COT sharing mechanism is performed based on an implicit open group manner in which whether a COT shared by another terminal is valid may be determined based on the evaluation results of the responding device terminal. A COT sharing evaluation standard of the responding device terminal may include the following criteria: an expected COT sharing range/zone, and channel quality measurement of the responding device terminal. The expected COT sharing range/zone may be determined by using an SL zone ID or through RSRP measurement or the like. The channel quality measurement of the responding device terminal may include, for example, a reference signal received power (RSRP) threshold or constant bit rate (CBR) related measurement.

### Determining of a CAPC

One CAPC value may correspond to one or more channel access parameters. Taking a network device as an example, Table 2 shows channel access parameters corresponding to different CAPC values (denoted by p in Table 2) on the side of the network device. In Table 2, mₚ is a quantity of backoff slots corresponding to p, CWₚ is a size of a contention window (CW) corresponding to p, CW_{min,p} is a minimum value of CWₚ corresponding to p, CW_{max,p} is a maximum value of CWₚ corresponding to p, and T_{mcot,p} is a maximum channel occupation time length corresponding to p.

TABLE 2

| Channel | | | | | |
|---|---|---|---|---|---|
| access priority | | | | | Allowed values |
| class (p) | mₚ | CW_{min, p} | CW_{max, p} | T_{mcot, p} | of CWₚ |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, |
| | | | | ms | 255, 511, 1023} |

The following uses NR-U as an example to describe a method for determining a CAPC in the Uu interface-based communications system.

CAPCs of radio bearers and medium access control control elements (MAC CE) may be fixed or configurable. For example, the CAPC may be fixed to the lowest priority for a padding buffer status report (BSR) and a recommended bit rate MAC CE; the CAPC may be fixed to the highest priority for a signalling radio bearer.

When choosing a CAPC of a DRB, a gNB takes into account 5QIs of all QoS flows multiplexed in the DRB while considering fairness between different traffic types and transmissions. Table 3 shows which CAPC should be used for which standardized 5QIs, i.e. which CAPC to use for a given QoS flow.

Note: A QoS flow corresponding to a non-standardized 5QI (i.e. operator specific 5QI) should use a CAPC of a standardized 5QI which best matches QoS characteristics of the non-standardized 5QI.

TABLE 3

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

Note:
A lower CAPC value means a higher priority-

When performing Type 1 LBT for transmission of an uplink transport block (transport block, TB) and a CAPC is not indicated in downlink control information (DCI), the terminal device shall select the CAPC. For example, if only MAC CE(s) are included in the TB, the highest priority CAPC of those MAC CE(s) is used; or if CCCH SDU(s) are included in the TB, the highest priority CAPC is used; or if DCCH SDU(s) are included in the TB, the highest priority CAPC of the DCCH(s) is used; or the lowest priority CAPC of logical channel(s) with MAC SDU multiplexed in the TB is used otherwise.

It may be learned from above that in the Uu interface communications system based on a grant-free spectrum, a CAPC is determined based on a configuration of a network device. Specifically, the network device may determine a CAPC value by referring to a QoS/5QI value. In sidelink communication based on a grant-free spectrum, there is no proper technical solution to determine a CAPC value.

FIG. 4 is a schematic flowchart of a method for sidelink communication according to an embodiment of this application, to resolve the foregoing problem. The method shown in FIG. 4 may include step S410.

Step S410: A first device determines a first CAPC value for sidelink communication.

The first device may be the communications device described above. For example, the first device may be a network device or a terminal device. In other words, a network device may determine the first CAPC value used by a terminal device for sidelink communication, and configure the first CAPC value for the terminal device, or a terminal device may determine the first CAPC value for sidelink communication. In some embodiments, a CAPC value may also be referred to as a CAPC level, that is, a first CAPC may also be referred to as a first CAPC level.

In a case that the first device is a network device, the method for sidelink communication provided in this application may alternatively include the method shown in FIG. 5. FIG. 5 may be executed by a network device and/or a terminal device. The method shown in FIG. 5 may include step S510.

Step S510: A network device may transmit configuration information of a CAPC to a terminal device. The configuration information of the CAPC may be used to indicate a first CAPC value.

The method shown in FIG. 5 may further include step S520.

Step S520: The terminal device performs sidelink communication based on the first CAPC value. For example, the terminal device may perform sidelink communication over a grant-free spectrum based on the first CAPC value.

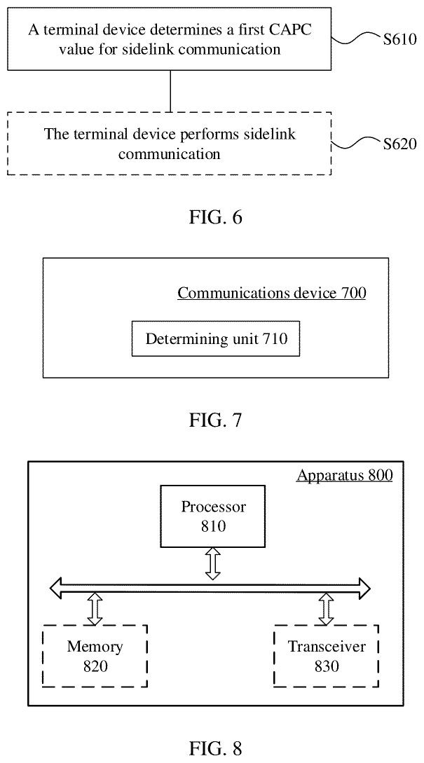

In a case that the first device is a terminal device, an embodiment of this application provides a method for sidelink communication shown in FIG. 6. The method shown in FIG. 6 may include step S610.

Step S610: A terminal device determines a first CAPC value for sidelink communication. In other words, the first CAPC value is determined by the terminal device by itself.

The method shown in FIG. 6 may further include step S620.

Step S620: The terminal device performs sidelink communication based on the first CAPC value.

A configuration granularity of the first CAPC value is not limited in this application. For example, the first CAPC value may correspond to one or more of the following: a logical channel, a QoS flow, a PQI, a priority, a radio bearer, a layer 2 identity, a service, a service type, a transmit profile (Tx profile), a cast type, a resource pool, or a data packet.

In an implementation, in a case that the first device is a network device, the first CAPC value may correspond to one or more of the following: a logical channel, a QoS flow, a PQI, a priority, a radio bearer, a layer 2 identity (ID), a service, a service type, a transmit profile, a cast type, or a resource pool. In other words, a determining granularity of a CAPC value may be one or more of each logical channel, each QoS flow, each PQI, each priority, each radio bearer, each layer 2 identity, each service, each service type, each transmit profile, each cast type, or each resource pool.

In another implementation, in a case that the first device is a terminal device, the first CAPC value may correspond to one or more of the following: a logical channel, a QoS flow, a PQI, a priority, a radio bearer, a layer 2 identity, a service, a service type, a transmit profile, a cast type, a resource pool, or a data packet.

It should be noted that the transmit profile may be used to indicate a release of a protocol used by the first terminal for transmission such as a release 12, or a characteristic used for transmission, where the characteristic may be whether to enable discontinuous reception (DRX). In some embodiments, the transmit profile may be alternatively a transmit file, a transmit parameter, or the like.

It should be noted that the cast type may be used to indicate unicast communication, multicast communication, or broadcast communication. In some embodiments, the cast type may also be referred to as a transmission cast type.

It should be noted that the first CAPC value is associated with a PQI. For example, a first CAPC may be determined based on a PQI. Alternatively, there may be a mapping relationship between the first CAPC and the PQI.

In this application, the first CAPC value for sidelink communication is determined based on the PQI, so that a CAPC value in a sidelink communications system can be determined.

It should be noted that if the configuration granularity of the first CAPC value varies, the case that the first CAPC is associated with the PQI also differs. For example, in a case that the first CAPC value corresponds to a QoS flow, the first CAPC value may be associated with a PQI of the QoS flow. In some implementations, if the first CAPC value is a CAPC value of a first QoS flow, the CAPC value of the first QoS flow may be determined based on a PQI of the first QoS flow. Alternatively, in a case that the configuration granularity of the first CAPC value is not a QoS flow, CAPC values of one or more QoS flows associated with the configuration granularity may be determined, and the first CAPC value may be one of the CAPC values of the one or more QoS flows. The CAPC values of the one or more QoS flows may be determined based on PQIs of the one or more QoS flows.

In some embodiments, one or more QoS flows may correspond to a same radio bearer/logical channel. For example, the one or more QoS flows correspond to a first radio bearer/logical channel. The first CAPC value may be a CAPC value of the first radio bearer/logical channel. In this case, the CAPC value (that is, the first CAPC value) of the first radio bearer/logical channel may be determined based on CAPC values of the one or more QoS flows, or the CAPC value of the first radio bearer/logical channel may be determined based on implementation of the first device. In other words, if the one or more QoS flows correspond to a same radio bearer/logical channel, which one of the CAPC values of the one or more QoS flows is selected as a CAPC value of the radio bearer/logical channel may be determined based on the CAPC values of the one or more QoS flows or implementation of the first device. The CAPC values of the one or more QoS flows may be determined based on PCIs of the one or more QoS flows.

In an implementation, the CAPC value of the first radio bearer/logical channel may be determined based on one or more of the following: a maximum value in the CAPC values of the one or more QoS flows, a minimum value in the CAPC values of the one or more QoS flows, a CAPC value of a QoS flow with the highest priority in the one or more QoS flows, a CAPC value of a QoS flow with the lowest priority in the one or more QoS flows, or a CAPC value of a QoS flow whose packet delay budget is the shortest in the one or more QoS flows. Alternatively, the CAPC value of the first radio bearer/logical channel may be determined based on another dimension parameter in QoS. Alternatively, the CAPC value of the first radio bearer/logical channel may be based on implementation of the first device.

In another implementation, CAPC values of QoS flows in the first radio bearer/logical channel are the same. In other words, the network device may map only QoS flows with a same CAPC value to the first radio bearer/logical channel.

In some implementations, the first CAPC value may be determined based on a first parameter. The first parameter may be associated with the PQI. In some embodiments, the first parameter may be one or more of dimension parameters corresponding to the PQI. For example, the first parameter may include one or more of the following: a value of the PQI (PQI value), a type of the PQI, a priority corresponding to the PQI, a packet delay budget (PDB) corresponding to the PQI, a resource type corresponding to the PQI, a packet error rate corresponding to the PQI, or another dimension parameter corresponding to the PQI. The following separately describes the foregoing parameters.

The value of the PQI may be any one of values shown in the first column of Table 1. For example, the value of the PQI may include 24, 25, 26, 60, 61, 92, 93, 21, 22, 23, 55, 56, 57, 58, 59, 90, 91, or a non-standard PQI.

The type of the PQI may be used to indicate that the PQI is standard or non-standard. The type of the PQI may include, for example, a standard PQI and a non-standard PQI.

The priority corresponding to the PQI may include a priority associated with the PQI. For example, the priority associated with the PQI may include a priority of a layer 1 data flow or a priority of a layer 2 data flow associated with the PQI. Alternatively, the priority associated with the PQI may include a default priority level of the PQI. A value of the default priority level may include 1, 2, 5, or 6.

The packet delay budget corresponding to the PQI may be any one of values shown in the fourth column of Table 1. For example, a value of the packet delay budget corresponding to the PQI may include 5 ms, 10 ms, 120 ms, 150 ms, 200 ms, or 400 ms.

The resource type corresponding to the PQI may be any one of values shown in the second column of Table 1. For example, the resource type corresponding to the PQI may include a guaranteed bit rate (GBR) type, a non-guaranteed bit rate (non-GBR) type, or a delay critical guaranteed bit rate (delay critical GBR) type.

A value of the packet error rate corresponding to the PQI may be any one of values shown in the fifth column of Table 1. For example, the value of the packet error rate corresponding to the PQI may include 10⁻², 10⁻³, 10⁻⁴, or 10⁻⁶.

The another dimension parameter corresponding to the PQI may include, for example, one or more of the following: a default maximum data burst volume or a default averaging window.

In some embodiments, the first CAPC value may correspond to a value of the first parameter. For example, in a case that the PQI is a standard PQI, the first CAPC value may correspond to a value of the first parameter. In an example in which the first parameter includes the value of the PQI and/or the packet delay budget corresponding to the PQI, a correspondence between the first CAPC value (denoted as a column “CAPC level” in the table) and the value of the PQI and/or the packet delay budget corresponding to the PQI may be shown in Table 4. It should be noted that Table 4 is only an example, and the first CAPC value may correspond to a value of another parameter that is associated with the PQI and that is different from that in Table 4. In addition, a correspondence between a PQI value and/or a value of a packet delay budget and a CAPC value in Table 4 is also an example. For example, in a case that the PQI value in Table 4 is 24, the CAPC value may be 2, but it is not excluded that when the PQI value is 24, the CAPC value may be 3 or 1.

TABLE 4

| PQI value | Packet delay budget | CAPC level |
|---|---|---|
| 24 | 150 ms | 2 |
| 25 | 200 ms | 2 |
| 26 | 200 ms | 2 |
| 60 | 120 ms | 2 |
| 61 | 400 ms | 3 |
| 92 | 5 ms | 1 |
| 93 | 10 ms | 1 |

In some embodiments, the first CAPC value may correspond to a value range of the first parameter. For example, in a case that the PQI is a non-standard PQI, the first CAPC value may correspond to a range of values of the first parameter. In an example in which the first parameter includes the packet delay budget corresponding to the PQI, a correspondence between the first CAPC value (denoted as a column “CAPC level” in the table) and the packet delay budget corresponding to the PQI may be shown in Table 5. It should be noted that Table 5 is only an example, and the first CAPC value may correspond to a range of values of another parameter that is associated with the PQI and that is different from that in Table 5. In addition, a correspondence between a PQI value and a range of values of a packet delay budget and a CAPC value in Table 5 is also an example. For example, in Table 5, in a case that a value range of the packet delay budget is 0-100 ms, the CAPC value may be 1, but it is not excluded that when the value range of the packet delay budget is 0-100 ms, the CAPC value may be 2 or 3. In addition, the value range is not limited in this application. For example, a packet delay budget may correspond to one first CAPC value per 100 ms. Alternatively, a packet delay budget may correspond to one first CAPC value per 50 ms.

TABLE 5

| PQI value | Packet delay budget | CAPC level |
|---|---|---|
| Non-standard PQI_1 | 0-100 ms | 1 |
| Non-standard PQI_2 | 100-200 ms | 2 |
| Non-standard PQI_3 | 200-300 ms | 3 |

In some embodiments, if the PQI is a standard PQI, the first CAPC value may correspond to a value of the first parameter; or if the PQI is a non-standard PQI, the first CAPC value may correspond to a range of values of the first parameter. In an example in which the first parameter includes the packet delay budget corresponding to the PQI, a correspondence between the first CAPC value (denoted as a column “CAPC level” in the table) and the packet delay budget corresponding to the PQI may be shown in Table 6. It should be noted that Table 6 is only an example, and the first CAPC value may correspond to a value of another parameter that is associated with a standard PQI and that is different from that in Table 6. The first CAPC value may correspond to a range of values of another parameter that is associated with a non-standard PQI and that is different from that in Table 6.

TABLE 6

| | | |
|---|---|---|
| PQI value | Packet delay budget | CAPC level |

| | | | |
|---|---|---|---|
| 24 | 150 | ms | 2 |
| 25 | 200 | ms | 2 |
| 61 | 400 | ms | 3 |
| 92 | 5 | ms | 1 |
| 93 | 10 | ms | 1 |
| Non-standard PQI | 0-100 | ms | 1 |
| Non-standard PQI_2 | 100-200 | ms | 2 |
| Non-standard PQI_3 | 200-300 | ms | 3 |

In some embodiments, if the PQI is a non-standard PQI, the first CAPC value may be a fixed value. The fixed value may be a specific level or a default level. For example, the fixed value may be 1, 2, 3, or 4. In some implementations, all non-standard PQIs may correspond to one fixed value.

In an implementation, in a case that the PQI is a standard PQI, the first CAPC value may correspond to a value of the first parameter; or in a case that the PQI is a non-standard PQI, the first CAPC value is a fixed value. In an example in which the first parameter includes the value of the PQI and/or the packet delay budget corresponding to the PQI, a correspondence between the first CAPC value (demoted as a column “CAPC level” in the table) and the value of the PQI and/or the packet delay budget corresponding to the PQI may be shown in Table 7. It should be noted that Table 7 is only an example, and the first CAPC value may correspond to a value of another parameter that is associated with a standard PQI and that is different from that in Table 7.

TABLE 7

| PQI value | Packet delay budget | CAPC level |
|---|---|---|
| 24 | 150 ms | 2 |
| 25 | 200 ms | 2 |
| 26 | 200 ms | 2 |
| 60 | 120 ms | 2 |
| 61 | 400 ms | 3 |
| 92 | 5 ms | 1 |
| 93 | 10 ms | 1 |
| Non-standard PQI | | Fixed value |

It may be learned from the foregoing technical solutions that, in a case that there is a non-standard PQI, a CAPC value corresponding to the PQI may also be determined in this application.

The foregoing describes in detail the determining manner (or referred to as a determining basis) of the first CAPC value, that is, how the first CAPC is associated with the PQI. The foregoing determining manner may be configured based on the following manner: for a terminal device in a connected state, being configured based on RRC signalling transmitted by the network device; for a terminal device in an idle state or an inactive state, being configured based on system information transmitted by the network device; or for a terminal device outside coverage of the network device, being configured based on pre-configuration information. The RRC signalling may be dedicated RRC signalling, and the system information may be system information broadcast (SIB).

In some implementations, the first CAPC value may be configured based on the following manner: for a terminal device in a connected state, being configured based on RRC signalling transmitted by the network device; for a terminal device in an idle state or an inactive state, being configured based on system information transmitted by the network device; or for a terminal device outside coverage of the network device, being configured based on pre-configuration information. The RRC signalling may be dedicated RRC signalling, and the system information may be SIB.

A configuration manner of the first CAPC is not limited in this application, that is, a manner of configuring the first CAPC is not limited in this application. In an implementation, the first CAPC may be configured by the network device, may be pre-configured, or may be independently determined by the terminal device.

In a case that the terminal device is outside coverage of the network device or in a non-connected state, the network device cannot configure an accurate CAPC for the terminal device based on QoS of the terminal device. Based on this application, the terminal device may determine the first CAPC value for sidelink communication by itself, or may determine the first CAPC by means of pre-configuration. Therefore, even if the terminal device is outside coverage or in a non-connected state, an accurate CAPC may still be determined in this application.

In an implementation, that the first CAPC value is configured by the network device or is independently determined by the terminal device is determined based on one or more of following: a connection state of the terminal device, a transmission mode of the terminal device, whether the terminal device is in coverage of the network device, configuration information of the network device, or a rule predefined in a protocol.

The connection state of the terminal device may include a connected state and a non-connected state. The non-connected state may include, for example, being outside the coverage, an idle state, or an inactive state.

The transmission mode of the terminal device may include the foregoing mode 1 or mode 2.

Whether the terminal device is in coverage of the network device may include being within the coverage or being outside the coverage.

The configuration information of the network device may be explicitly or implicitly configured. The explicit configuration is indicated, for example, by using indication information of one bit. The implicit configuration may be indicated, for example, by whether there are specified fields in system information and/or specific signalling.

The rule predefined in the protocol may be determined based on one or more of a type of a PQI (a standard PQI or a non-standard PQI), channel quality, a resource pool, a load condition, an indication of a peer terminal device, or an LBT situation.

For example, for a terminal device in a connected state, the first CAPC value is configured by the network device. Alternatively, for a terminal device in a non-connected state, the first CAPC value is independently determined by the terminal device. Alternatively, for a terminal device in a connected state, a terminal device in an idle state, and a terminal device in an inactive state, the first CAPC value is configured by the network device. Alternatively, for a terminal device outside coverage of the network device, the first CAPC value is independently determined by the terminal device.

The foregoing describes in detail the method embodiments of this application with reference to FIG. 1 to FIG. 6. The following describes in detail apparatus embodiments of this application with reference to FIG. 7 and FIG. 8. It should be understood that the description of the method embodiments corresponds to the description of the apparatus embodiments, and therefore, for parts that are not described in detail, refer to the foregoing method embodiments.

FIG. 7 is a schematic structural diagram of a communications device 700 according to an embodiment of this application. The communications device 700 may include a determining unit 710.

The determining unit 710 may be configured to determine a first CAPC value for sidelink communication, where the first CAPC value is associated with a PQI.

In at least one embodiment, that the first CAPC value is associated with a PQI includes: the first CAPC value is determined based on a first parameter, and the first parameter is associated with the PQI.

In at least one embodiment, the first parameter includes one or more of the following: a value of the PQI; a type of the PQI; a priority corresponding to the PQI; a packet delay budget corresponding to the PQI; a resource type corresponding to the PQI; or a packet error rate corresponding to the PQI, where the type of the PQI includes a standard PQI and a non-standard PQI.

In at least one embodiment, if the PQI is a non-standard PQI, the first CAPC value is a fixed value.

In at least one embodiment, if the PQI is a non-standard PQI, the first CAPC value corresponds to a value range of the first parameter.

In at least one embodiment, if the PQI is a standard PQI, the first CAPC value corresponds to a value of the first parameter.

In at least one embodiment, the first CAPC value corresponds to one of the following: a logical channel, a QoS flow, a PQI, a priority, a radio bearer, a layer 2 identity, a service, a service type, a transmit profile, a cast type, a resource pool, or a data packet.

In at least one embodiment, the first CAPC value is a CAPC value of a first QoS flow, and the CAPC value of the first QoS flow is determined based on a PQI of the first QoS flow.

In at least one embodiment, the first CAPC value is a CAPC value of a first radio bearer/logical channel, the first radio bearer/logical channel includes one or more QoS flows, and the CAPC value of the first radio bearer/logical channel is determined based on CAPC values of the one or more QoS flows or implementation of the communications device.

In at least one embodiment, the CAPC value of the first radio bearer/logical channel is determined based on one or more of the following: a maximum value in the CAPC values of the one or more QoS flows; a minimum value in the CAPC values of the one or more QoS flows; or a CAPC value of a QoS flow whose packet delay budget is the shortest in the one or more QoS flows.

In at least one embodiment, CAPC values of QoS flows in the first radio bearer/logical channel are the same.

In at least one embodiment, the first CAPC value is configured by a network device, is pre-configured, or is independently determined by a terminal device.

In at least one embodiment, the first CAPC value is configured in the following manner: for a terminal device in a connected state, being configured based on RRC signalling transmitted by the network device; for a terminal device in an idle state or an inactive state, being configured based on system information transmitted by the network device; or for a terminal device outside coverage of the network device, being configured based on pre-configuration information.

In at least one embodiment, a determining manner of the first CAPC value is configured based on one of the following manners: for a terminal device in a connected state, being configured based on RRC signalling transmitted by the network device; for a terminal device in an idle state or an inactive state, being configured based on system information transmitted by the network device; or for a terminal device outside coverage of the network device, being configured based on pre-configuration information.

In at least one embodiment, that the first CAPC value is configured by a network device or is independently determined by a terminal device is determined based on one or more of the following: a connection state of the terminal device; a transmission mode of the terminal device; whether the terminal device is in coverage of the network device; configuration information of the network device; or a rule predefined in a protocol.

In at least one embodiment, the first CAPC value is determined based on one of the following: for a terminal device in a connected state, the first CAPC value is configured by the network device; for a terminal device in a non-connected state, the first CAPC value is independently determined by the terminal device; for a terminal device in a connected state, a terminal device in an idle state, and a terminal device in an inactive state, the first CAPC value is configured by the network device; or for a terminal device outside coverage of the network device, the first CAPC value is independently determined by the terminal device.

FIG. 8 is a schematic structural diagram of a communications apparatus according to an embodiment of this application. Dashed lines in FIG. 8 indicate that the unit or module is optional. The apparatus 800 may be configured to implement the methods described in the foregoing method embodiments. The apparatus 800 may be a chip, a terminal device, or a network device.

The apparatus 800 may include one or more processors 810. The processor 810 may support the apparatus 800 in implementing the methods described in the foregoing method embodiments. The processor 810 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 800 may further include one or more memories 820. The memory 820 stores a program. The program may be executed by the processor 810, to cause the processor 810 to execute the methods described in the foregoing method embodiments. The memory 820 may be separate from the processor 810 or may be integrated into the processor 810.

The apparatus 800 may further include a transceiver 830. The processor 810 may communicate with another device or chip by using the transceiver 830. For example, the processor 810 may transmit data to and receive data from another device or chip by using the transceiver 830.

An embodiment of this application further provides a computer-readable storage medium, configured to store a program. The computer-readable storage medium may be applied to a terminal or a network device provided in embodiments of this application, and the program causes a computer to execute the methods to be executed by the terminal or the network device in embodiments of this application.

An embodiment of this application further provides a computer program product. The computer program product includes a program. The computer program product may be applied to a terminal or a network device provided in embodiments of this application, and the program causes a computer to execute the methods to be executed by the terminal or the network device in embodiments of this application.

An embodiment of this application further provides a computer program. The computer program may be applied to a terminal or a network device provided in embodiments of this application, and the computer program causes a computer to execute the methods to be executed by the terminal or the network device in embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should be further understood that determining B based on A does not mean determining B based on only A, but instead B may be determined based on A and/or other information.

In embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

In embodiments of this application, “predefined” or “pre-configured” may be implemented by prestoring corresponding code or a corresponding table in a device (for example, including a terminal device and a network device) or in other manners that can be used for indicating related information, and a specific implementation thereof is not limited in this application. For example, being predefined may refer to being defined in a protocol.

In embodiments of this application, the “protocol” may indicate a standard protocol in the communications field, which may include, for example, an LTE protocol, an NR protocol, and a related protocol applied to a future communications system. This is not limited in this application.

In embodiments of this application, the term “and/or” describes merely an association relationship between associated objects, and represents that there may be three relationships. For example, A and/or B may represent three cases: only A exists, both A and B exist, and only B exists. In addition, the character “/” herein generally indicates an “or” relationship between associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by persons skilled in the art within the technical scope disclosed in this application shall fall within the protection scope of this application. Therefore, the protection scope of this application shall be subject to the protection scope of the claims.

What is claimed is:

1. A method for sidelink communication, comprising:
determining, by a first device, a first channel access priority class (CAPC) value for sidelink communication,
wherein the first CAPC value is associated with a PC5 quality of service index (PQI).

2. The method according to claim 1, wherein that the first CAPC value is associated with a PQI comprises: the first CAPC value is determined based on a first parameter.

3. The method according to claim 2, wherein the first parameter comprises one or more of following:
a value of the PQI;
a type of the PQI;
a packet delay budget corresponding to the PQI; or
a packet error rate corresponding to the PQI;
wherein the type of the PQI comprises a standard PQI and a non-standard PQI.

4. The method according to claim 2, wherein if the PQI is a non-standard PQI, the first CAPC value is a fixed value; or
if the PQI is a non-standard PQI, the first CAPC value corresponds to a value range of the first parameter.

5. The method according to claim 2, wherein if the PQI is a standard PQI, the first CAPC value corresponds to a value of the first parameter.

6. The method according to claim 1, wherein the first CAPC value is a CAPC value of a first radio bearer/logical channel, the first radio bearer/logical channel comprises one or more QoS flows, and the CAPC value of the first radio bearer/logical channel is determined based on CAPC values of the one or more QoS flows or implementation of the first device.

7. The method according to claim 6, wherein the CAPC value of the first radio bearer/logical channel is determined based on one or more of following:
a maximum value in the CAPC values of the one or more QoS flows;
a minimum value in the CAPC values of the one or more QoS flows; or
a CAPC value of a QoS flow whose packet delay budget is the shortest in the one or more QoS flows.

8. The method according to claim 1, wherein the first CAPC value is configured by a network device, is pre-configured, or is independently determined by a terminal device.

9. A communications device, comprising a memory and a processor, wherein the memory is configured to store a program, and the processor is configured to invoke the program in the memory and run the computer program, to cause a wireless communication method, comprising:
determining, by a first device, a first channel access priority class (CAPC) value for sidelink communication,
wherein the first CAPC value is associated with a PC5 quality of service index (PQI).

10. The communications device according to claim 9, wherein that the first CAPC value is associated with a PQI comprises: the first CAPC value is determined based on a first parameter.

11. The communications device according to claim 10, wherein the first parameter comprises one or more of following:
a value of the PQI;
a type of the PQI;
a packet delay budget corresponding to the PQI; or
a packet error rate corresponding to the PQI;
wherein the type of the PQI comprises a standard PQI and a non-standard PQI.

12. The communications device according to claim 10, wherein if the PQI is a non-standard PQI, the first CAPC value is a fixed value; or
if the PQI is a non-standard PQI, the first CAPC value corresponds to a value range of the first parameter.

13. The communications device according to claim 10, wherein if the PQI is a standard PQI, the first CAPC value corresponds to a value of the first parameter.

14. The communications device according to claim 9, wherein the first CAPC value is a CAPC value of a first radio bearer/logical channel, the first radio bearer/logical channel comprises one or more QoS flows, and the CAPC value of the first radio bearer/logical channel is determined based on CAPC values of the one or more QoS flows or implementation of the communications device.

15. The communications device according to claim 14, wherein the CAPC value of the first radio bearer/logical channel is determined based on one or more of following:
a maximum value in the CAPC values of the one or more QoS flows;
a minimum value in the CAPC values of the one or more QoS flows; or
a CAPC value of a QoS flow whose packet delay budget is the shortest in the one or more QoS flows.

16. The communications device according to claim 9, wherein the first CAPC value is configured by a network device, is pre-configured, or is independently determined by a terminal device.

17. The communications device according to claim 16, wherein the first CAPC value is configured in following manner:
for a terminal device in a connected state, being configured based on radio resource control RRC signalling transmitted by the network device; or
for a terminal device in an idle state or an inactive state, being configured based on system information transmitted by the network device; or
for a terminal device outside coverage of the network device, being configured based on pre-configuration information.

18. The communications device according to claim 16, wherein that the first CAPC value is configured by a network device or is independently determined by a terminal device is determined based on one or more of following:
a connection state of the terminal device;
whether the terminal device is in coverage of the network device;
configuration information of the network device; or
a rule predefined in a protocol.

19. The communications device according to claim 18, wherein the first CAPC value is determined based on one of following:
for a terminal device in a connected state, the first CAPC value is configured by the network device;
for a terminal device in a non-connected state, the first CAPC value is independently determined by the terminal device;
for a terminal device in a connected state, a terminal device in an idle state, and a terminal device in an inactive state, the first CAPC value is configured by the network device; or
for a terminal device outside coverage of the network device, the first CAPC value is independently determined by the terminal device.

20. A communications device, comprising a memory and a processor, wherein the memory is configured to store a program, and the processor is configured to invoke the program in the memory to cause the communications device to execute the method according to claim 1.
